(19) United States
(12) Patent Application Publication
(10) Pub. No.: US 2007/0260458 A1
(43) Pub. Date: Nov. 8, 2007

(54) Subword parallelism method for processing multimedia data and apparatus for processing data using the same

(75) Inventors: Jong-Myon Kim, Yongin-si (KR); Dongsoo Kang, Hwasung-si (KR); Kyoung-June Min, Yongin-si (KR); Eun-Jin Ryu, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/710,855

(22) Filed: Feb. 26, 2007

(30) Foreign Application Priority Data
Feb. 24, 2006 (KR) 18478/2006

(51) Int. Cl. G10L 15/00

(52) U.S. Cl. 704/252

(57) ABSTRACT

Disclosed is a parallel processing method in a data processing system that temporarily loads data stored in a memory in word registers and parallel-processes subwords constituting the loaded word using Arithmetic Logic Units (ALUs) which are equal in size to the subwords. The method includes generating a shortened subword by removing at least one bit among the bits constituting each subword; and performing parallel computation on the shortened subwords.

### PRIORITY

This application claims priority under 35 U.S.C. § 119(a) to a Korean Patent Application filed in the Korean Intellectual Property Office on Feb. 24, 2006 and assigned Serial No. 2006-18478, the disclosure of which is incorporated herein by reference.

### BACKGROUND OF THE INVENTION

1. Field of the Invention

The present invention relates generally to a data processing technique for a portable multimedia apparatus and an apparatus for processing data using the same, and in particular, to a subword parallelism method for efficiently processing multimedia data and an apparatus for processing data using the same.

2. Description of the Related Art

In a multichannel image coding scheme, standard images can be expressed with image signals based on vector values, and each pixel of the images is composed of three components, i.e., Red, Green and Blue (RGB). However, the RGB color space is not suitable for image processing because signal correlation between color components of an RGB image is high and each of the color components has a broad band. In order to solve this problem, the image and video processing field universally uses a YCbCr color space which is suitable for the visual characteristics of human beings by reducing the signal correlation between the color components and reducing the total amount of generated data.

The YCbCr color space is a color coordinate space based on the color perceptibility of the humans, and because the human eye is less susceptible to high frequency in terms of chrominance (for example, Cb and Cr), humans cannot recognize color distortion with the naked eye even though it undergoes undersampling. In addition, a luminance component Y of the image can be processed independently of the chrominance components Cb and Cr.

Meanwhile, a subword parallelism technique that can simultaneously operate for several small data elements, like 8-bit pixels, is used for image processing. For subword parallelism, several small data elements (for example, 8-bit pixels) are packed in one large register (for example, 32-bit or 64-bit register), and the individual elements are processed in parallel by one instruction.

FIG. 1 is a conceptual diagram of the conventional subword parallelism technique.

Referring to FIG. 1, in a 32-bit parallel processing mechanism divided into four 8-bit Arithmetic Logic Units (ALUs) 110, 120, 130 and 140, two 32-bit words 11 and 13, including information, are being processed.

The words 11 and 13 each include 3 subwords having Y, Cb and Cr information. In this case, the 8 Most Significant Bit (MSB) bits of each word are unused. The subwords undergo computation in their associated ALUs 110, 120, 130 and 140, and are output as another word 15.

However, in the subword parallelism technique, overflow or underflow may occur during arithmetic computation (for example, addition and subtraction) which is most frequently used for image processing, and thus overhead for handling the overflow or underflow may also occur, affecting performance.

FIGS. 2A and 2B are conceptual diagrams of a packing/unpacking process in the conventional subword parallelism technique.

Referring to FIG. 2A, in order to solve the overflow or underflow problem occurring in the conventional subword parallelism technique, the packing/unpacking process shifts an 8-bit Y₁ value of a first register R₁ to a third 32-bit register R₃, and an 8-bit Y₂ value of a second register R₂ to a fourth 32-bit register R₄. The computation result on the 8-bit Y₁ value of the third register R₃ and the 8-bit Y₂ value of the fourth register R₄, obtained in response to a computation instruction, is stored in a fifth 32-bit register R₅.

Referring to FIG. 2B, there is shown an example of storing 16-bit values stored in a first register R₁ and a second register R₂, in a third 32-bit register R₃ divided into 8 bit segments. In this case, a value greater than 255 among the values C₀, C₁, C₂ and C₃, if any, is stored in a designated position of the third divided register R₃. However, this packing/unpacking process causes performance degradation of the image processing technique, and various process architectures are being proposed to reduce the computation overhead.

FIG. 3 is a conceptual diagram of the conventional 48-bit datapath subword parallelism technique.

Referring to FIG. 3, the conventional 48-bit datapath subword parallelism technique uses four 12-bit ALUs for 8-bit pixel processing. In this case, the technique can perform 8-bit data computations in their associated 12-bit ALUs 310, 320, 330 and 340, and store the resulting values in a respective 12-bit storage 37, thereby solving the overflow the underflow problem which may occur in the 8-bit computation. However, this may cause an undesirable increase in hardware size and cost.

### SUMMARY OF THE INVENTION

An aspect of the present invention is to address at least the problems and/or disadvantages and to provide at least the advantages described below. Accordingly, an aspect of the present invention is to provide a subword parallelism method capable of preventing overflow or underflow which may occur during multimedia data processing, without an increase in hardware, and an apparatus for processing data using the same.

Another aspect of the present invention is to provide a subword parallelism method capable of reducing the processing delay due to overhead instruction by reducing a bit width of input data, and an apparatus for processing data using the same.

The above and other aspects of the present invention can be achieved by a subword parallelism method in a data processing system that processes in parallel the subwords constituting a word obtained by temporarily loading in word registers the data stored in a memory, using ALUs which are equal in size to the subwords.

According to one aspect of the present invention, there is provided a parallel processing method in a data processing system that temporarily loads data stored in a memory in word registers and parallel-processes subwords constituting the loaded word using Arithmetic Logic Units (ALUs) which are equal in size to the subwords. The method includes generating a shortened subword by removing at least one bit among the bits constituting each subword; and performing parallel computation on the shortened subwords.

According to another aspect of the present invention, there is provided a parallel processing method in a data processing system that temporarily loads data stored in a memory in 32-bit word registers in units of 8-bit subwords and parallel-processes the subwords using four 8-bit Arithmetic Logic Units (ALUs). The method includes right-shifting each subword by a predetermined number of bits and outputting the right-shifted subword as a shortened subword; and delivering the shortened subwords to their associated ALUs and performing parallel computation thereon.

According to further another aspect of the present invention, there is provided an apparatus for processing data in a data processing system. The apparatus includes a memory for storing data; two registers for temporarily storing the data stored in the memory in units of subwords; and Arithmetic Logic Units (ALUs) for right-shifting the subword stored in each register by at least one bit, and performing computation on the two right-shifted subwords output from the two registers.

According to yet another aspect of the present invention, there is provided an apparatus for processing data in a data processing system. The apparatus includes a memory for storing data; two registers for temporarily storing the data stored in the memory in units of subwords; and Arithmetic Logic Units (ALUs) for right-shifting the subword stored in each register by at least one bit, performing sign bit extension on each right-shifted subword, and performing computation on the two sign bit-extended subwords output from the two registers.

According to still another aspect of the present invention, there is provided an apparatus for processing data in a data processing system. The apparatus includes a memory for storing data; two registers for dividing the data stored in the memory into subwords, right-shifting the divided subwords separately by at least one bit, and temporarily storing the right-shifted subwords; and Arithmetic Logic Units (ALUs) for performing computation on the subwords stored in the registers.

### BRIEF DESCRIPTION OF THE DRAWINGS

The above and other objects, features and advantages of the present invention will become more apparent from the following detailed description when taken in conjunction with the accompanying drawings in which:

FIG. 1 is a conceptual diagram of the conventional subword parallelism technique;

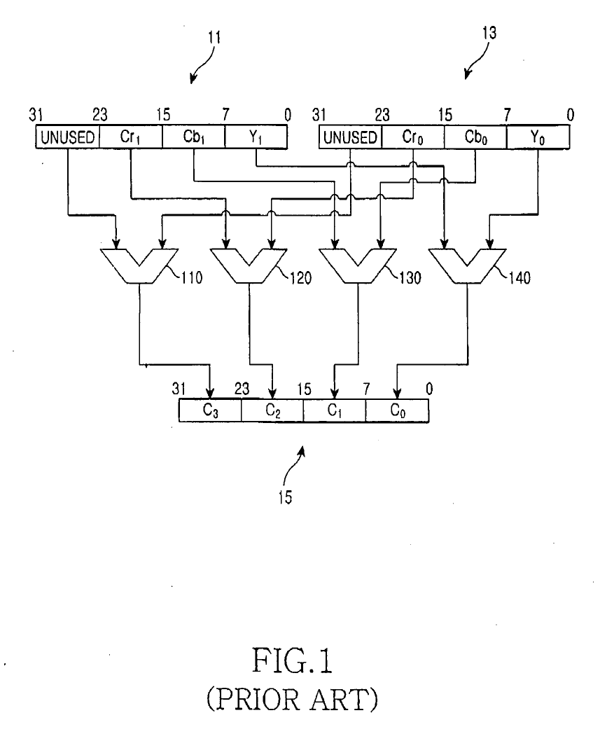

FIGS. 2A and 2B are conceptual diagrams of a packing/unpacking process in the conventional subword parallelism technique;

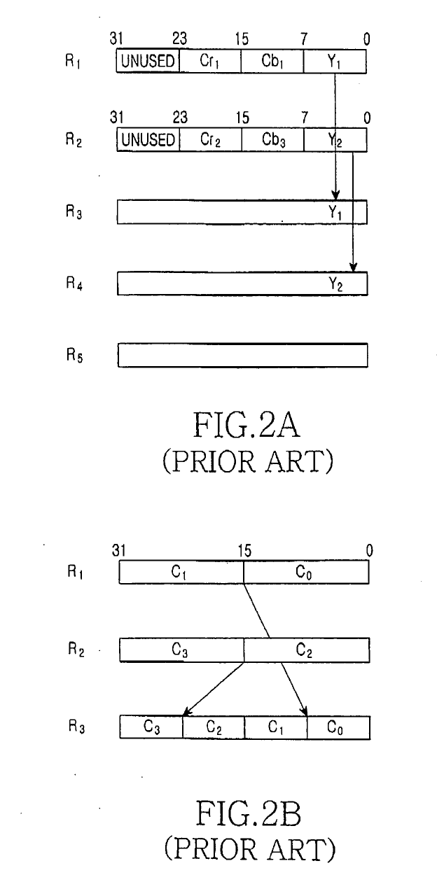

FIG. 3 is a conceptual diagram of the conventional 48-bit datapath subword parallelism technique;

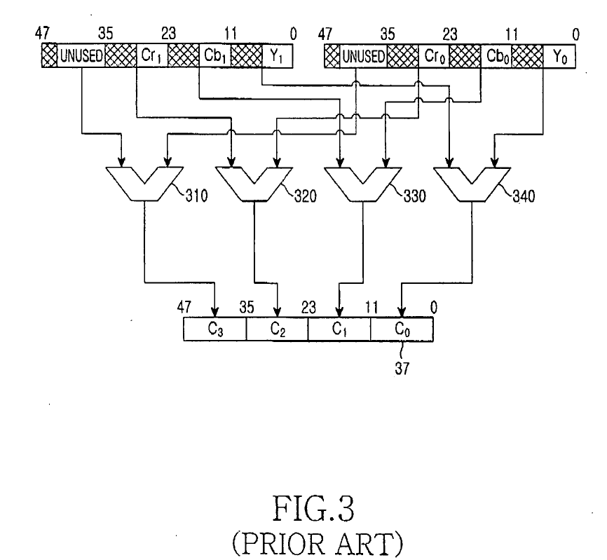

FIG. 4 is a conceptual diagram of a subword parallelism method according to an embodiment of the present invention; and

FIG. 5 is a conceptual diagram of a subword parallelism method according to another embodiment of the present invention.

### DETAILED DESCRIPTION OF EXEMPLARY EMBODIMENTS

Exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

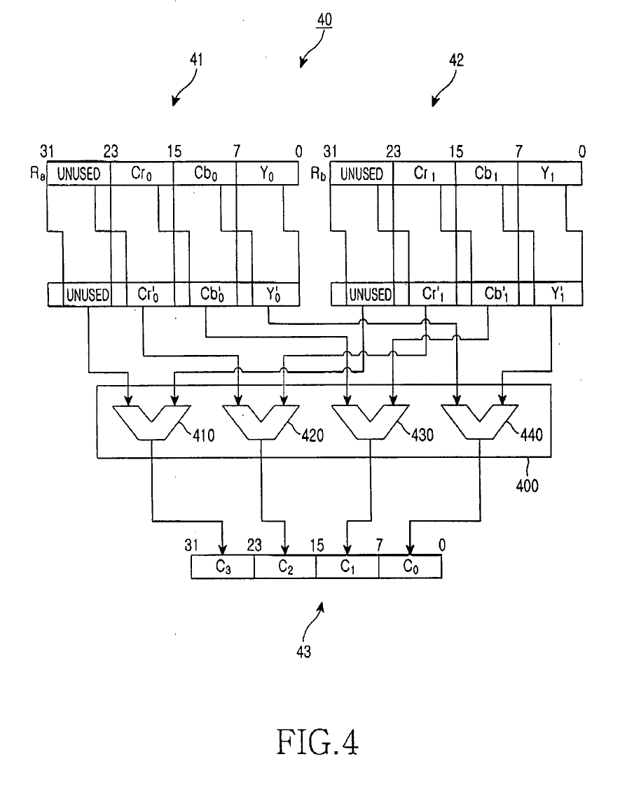

FIG. 4 is a conceptual diagram of a subword parallelism method according to an embodiment of the present invention.

Referring to FIG. 4, the new subword parallelism method according to an embodiment of the present invention intactly uses a 32-bit parallel processing apparatus 400, which is divided into the conventional 8-bit Arithmetic Logic Units (ALUs) 410, 420, 430 and 440.

This embodiment will be described with reference to an exemplary process of parallel-computing four 8-bit data signals stored in two 32-bit registers 41 and 42.

In the first register (Rₐ) 41, 8-bit subwords Y₀, Cb₀ and Cr₀ are arranged in sequence from the Least Significant Bit (LSB) position. In the second register (R_{b}) 42, 8-bit subwords Y₁, Cb₁,Cr₁ are arranged in sequence from the LSB position. The surplus positions in the first register (Rₐ) 41 and the second register (R_{b}) 42 are unused.

The subwords stored in the first and second registers 41 and 42 are right-shifted by a predetermined number ‘8−n’, and then input to their associated ALUs. Herein, it is preferable that n is greater than or equal to 1, and less than or equal to 4 (1≦n≦4).

For example, a 6-bit subword Y′₀ obtained by right-shifting a subword Y₀ of the first register 41 by 2, and a subword Y′₁ obtained by right-shifting a subword Y₁ of the second register 42 by 2 are input to an 8-bit ALU 440, and the computation results of the 8-bit ALU 440 are stored in a third register 43 as an 8-bit subword C₀. In addition to the right shifting, it is preferable to perform sign bit extension for processing negative numbers.

Although this embodiment has been described with reference to the 32-bit datapath architecture by way of example, the present invention is not limited thereto and can also be applied to 64-bit or 128-bit datapath architecture. In addition, although this embodiment has been described with reference to the data processing method for the YCbCr color space by way of example, the present invention is not limited thereto and can also be applied to data processing in other color spaces, like the YUV and YIQ color spaces.

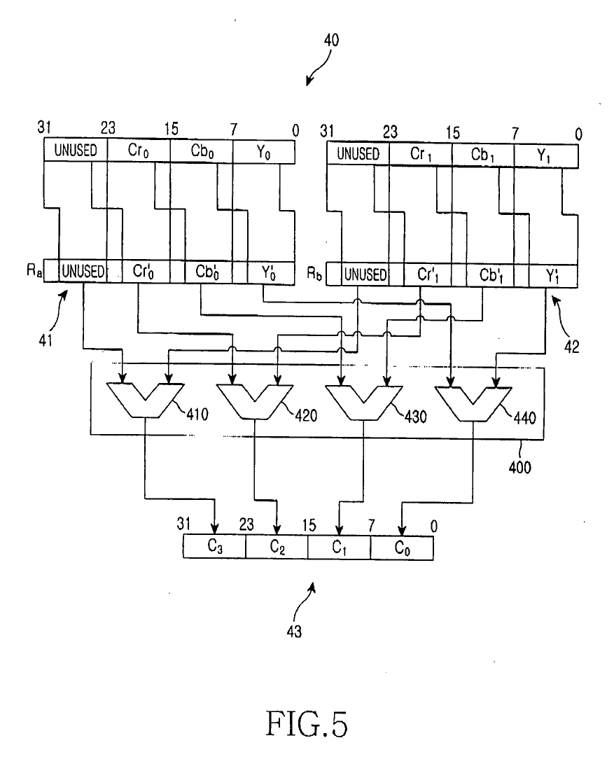

FIG. 5 is a conceptual diagram for a description of a subword parallelism method according to another embodiment of the present invention.

Referring to FIG. 5, this embodiment, unlike the former embodiment, performs right shifting and sign bit extension when loading the data stored in a memory 40 in 32-bit registers 41 and 42. This embodiment is equal in effect to the former embodiment.[FIG. 5 SEEMS TO BE IDENTICAL TO FIG. 4, WITH THE ADDITION OF REFERENCE NUMERAL 40. PLEASE, ADVISE. ALSO, PLEASE CHANGE THE SUBSCRIPTS FOR Y, Cr AND Cr IN FIG. 5 AS SHOWN ABOVE FOR FIG. 4.]

The present invention solves the overflow problem in the ALUs by reducing the number of bits of pixel data. This is possible because in the YCbCr color space, the reduction in the number of component bits may not cause noticeable quality degradation. The subword parallelism method of the present invention limits the number ‘n’ of shifting bits to a range of 1≦n≦4 to prevent noticeable quality degradation.

As can be understood from the foregoing description, the new subword parallelism method reduces the number of bits constituting a pixel (or subword) within a given limit for preventing noticeable quality degradation, thereby preventing the overflow or underflow which may occur due to additional computation.

In addition, the new subword parallelism method does not need the packing/unpacking process because it reduces the length of subwords during computation, thereby minimizing processing delay due to processing overhead.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A parallel processing method in a data processing system that temporarily loads data stored in a memory in word registers and parallel-processes subwords constituting the loaded word using Arithmetic Logic Units (ALUs) which are equal in size to the subwords, the method comprising:
generating a shortened subword by removing at least one bit among the bits constituting each subword; and
performing parallel computation on the shortened subwords.

2. The parallel processing method of claim 1, wherein generating the shortened subword comprises:
loading the data from the memory in the register in units of subwords; and
right-shifting at least one bit constituting each subword loaded in the register.

3. The parallel processing method of claim 2, wherein the number of right-shifted bits is greater than or equal to 1, and less than or equal to 4.

4. The parallel processing method of claim 1, wherein generating the shortened subword comprises:
loading the data from the memory in the register in units of subwords;
right-shifting at least one bit constituting each subword loaded in the register; and
performing sign bit extension on each right-shifted subword.

5. The parallel processing method of claim 4, wherein the number of right-shifted bits is greater than or equal to 1, and less than or equal to 4.

6. The parallel processing method of claim 1, wherein generating the shortened subword comprises:
grouping the data output from the memory in units of subwords;
right-shifting each subword at least one bit; and
loading the right-shifted subwords in the register.

7. The parallel processing method of claim 6, wherein the number of right-shifted bits is greater than or equal to 1, and less than or equal to 4.

8. The parallel processing method of claim 1, wherein generating the shortened subword comprises:
grouping the data output from the memory in units of subwords;
right-shifting each subword at least one bit; and
performing sign bit extension on each right-shifted subword.

9. The parallel processing method of claim 8, wherein the number of right-shifted bits is greater than or equal to 1, and less than or equal to 4.

10. A parallel processing method in a data processing system that temporarily loads data stored in a memory in 32-bit word registers in units of 8-bit subwords and parallel-processes the subwords using four 8-bit Arithmetic Logic Units (ALUs), the method comprising:
right-shifting each subword by a predetermined number of bits and outputting the right-shifted subword as a shortened subword; and
delivering the shortened subwords to their associated ALUs and performing parallel computation thereon.

11. The parallel processing method of claim 10, wherein the number of right-shifted bits is greater than or equal to 1, and less than or equal to 4.

12. An apparatus for processing data in a data processing system, the apparatus comprising:
a memory for storing data;
two registers for temporarily storing the data stored in the memory in units of subwords; and
Arithmetic Logic Units (ALUs) for right-shifting the subword stored in each register by at least one bit, and performing computation on the two right-shifted subwords output from the two registers.

13. The apparatus of claim 12, further comprising a register for temporarily storing the right-shifted subwords.

14. The apparatus of claim 12, wherein the number of the right-shifted bits is greater than or equal to 1, and less than or equal to 4.

15. An apparatus for processing data in a data processing system, the apparatus comprising:
a memory for storing data;
two registers for temporarily storing the data stored in the memory in units of subwords; and
Arithmetic Logic Units (ALUs) for right-shifting the subword stored in each register by at least one bit, performing sign bit extension on each right-shifted subword, and performing computation on the two sign bit-extended subwords output from the two registers.

16. The apparatus of claim 15, wherein the number of right-shifted bits is greater than or equal to 1, and less than or equal to 4.

17. An apparatus for processing data in a data processing system, the apparatus comprising:
a memory for storing data;
two registers for dividing the data stored in the memory into subwords, right-shifting the divided subwords separately by at least one bit, and temporarily storing the right-shifted subwords; and
Arithmetic Logic Units (ALUs) for performing computation on the subwords stored in the registers.

18. The apparatus of claim 17, wherein the number of right-shifted bits is greater than or equal to 1, and less than or equal to 4.
